(19) United States
(12) Patent Application Publication
(10) Pub. No.: US 2004/0239713 A1
(43) Pub. Date: Dec. 2, 2004

(54) Error-processing system and method for printers

(76) Inventor: Hyung-jong Kang, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/776,216

(22) Filed: Feb. 12, 2004

(30) Foreign Application Priority Data
Jun. 2, 2003 (KR) 2003-35445

(51) Int. Cl. B41J 29/393

(52) U.S. Cl. 347/19

(57) ABSTRACT

Disclosed is an error-processing system and method for printers. An error-processing method for an error-processing system for printers wherein the system has a user terminal installed with a printer driver to control drives of a printer and a printer server connected through the internet, according to embodiments of the present invention, comprises steps of sending an error recovery request signal to the printer server if an error occurs during print jobs for print data in use of the printer; providing the user terminal with a debug utility capable of capturing information related to the error if the error recovery request signal is received; installing the debug utility transferred from the printer server into the printer driver and sending the information captured by the installed debug utility to the printer server; and receiving the information captured by the debug utility from the user terminal, finding out and solving a cause of the error, and sending the result to the user terminal. Accordingly, the present invention enables service technicians or printer developers to simulate and solve errors without direct visits to the sites where faulty printers are located, to thereby reduce the time required to fix the errors.

### CROSS-REFERENCE TO RELATED APPLICATIONS

This application claims benefit under 35 U.S.C. §119(a) from Korean Patent Application No. 2003-35445, filed Jun. 2, 2003, in the Korean Intellectual Property Office, the disclosure of which is incorporated herein by reference in its entirety.

### BACKGROUND

1. Field of the Invention

The present invention relates to an error-processing system and method for printers. More particularly, the present invention relates to an error-processing system and method for printers enabling printer developers or service technicians to solve problems upon error occurrence in the printers without visits to the location where the printers having the problems are placed.

2. Description of the Related Art

In general, printers are devices that print and output onto sheets of paper documents prepared by other devices such as computers. Printers typically receive documents prepared in an application program of a computer and perform print jobs according to established print conditions.

In order for printers to print documents prepared in application programs for computers, a printer driver program should be installed in the computers to drive the printers. The printer driver converts documents prepared in application programs for computers into a language the printers can interpret.

If a user desires to print a document (referred to as “print document,” hereinafter) using a printer, the user sets up print conditions such as the kind of paper, print range, the number of sheets, print format, and so on. The print conditions are set by the user using a print condition information setting window provided by a printer driver. When a print command is applied after the print conditions are set up, the printer driver converts data (referred to as “print data”, hereinafter) into a data format the printer can interpret, and sends the formatted print data to the printer. The printer performs print jobs from the print data transferred from a computer.

If an error occurs in the printer during a print job, it is helpful for the user to know a cause of the error occurrence in order to solve the problem. If the error has occurred in the printer due to a mechanical problem such as a paper jam or the toner being depleted, the error can be cured by the user. However, if the error has come from software defects such as a printer driver error, it is difficult for the user to determine the cause of the error occurrence. In cases in which the user cannot determine the cause of the error occurrence as above, or simply has no idea how to solve the error even though he or she has determined the cause of the error occurrence, the user usually requests a service center to fix the problem.

If a service request is received from a user, the service center typically asks the user about the type of error that has occurred, the system environments for the computer with the printer driver installed, among other things. However, if the user has insufficient knowledge on a computer, a problem occurs since the user has difficulty answering the questions. Under such circumstances, service technicians sometimes must visit the location where the print system is located, check the computer system environments, the printer driver, the printer, and so on, to determine what the problem is and make efforts to fix the problem. If the cause of the error is still not determined or fixed by the service technicians, the printer is typically sent to the printer developers. In this case, the printer developers attempt to simulate the same problem in the printer using information obtained thus far in order to solve the problem. Alternately, the printer developers may need to directly visit the site to determine and solve the problem.

Due to the above described problems with conventional printers, significant time and effort is wasted when error conditions occur in printers. Service technicians and printer developers are required to directly visit the location with the printer exists in order to diagnose and solve errors.

### SUMMARY OF THE INVENTION

Accordingly, it is an aspect of the present invention to provide an error-processing system and method for printers enabling service technicians or printer developers to determine and fix errors in the printers without visits to sites where the printers are located when error recovery requests for the printer errors are received from user terminals.

In order to achieve the above aspects, an error-processing system for printers according to an embodiment of the present invention comprises a user terminal installed with a print driver for controlling drives of a printer, and for sending an error recovery request signal to an external server providing information on the printer when an error occurs during a print job. The error processing system further comprises a printer server for providing the user terminal with a debug utility program capable of capturing information related to the error if the error recovery request signal is received, and, if the information captured by the debug utility is received from the user terminal, using the received information to find out the cause of the error and solve the error. The system further provides the result to the user terminal, wherein the user terminal installs the debug utility into the printer driver and sends to the printer server the information captured by the installed debug utility.

The user terminal preferably includes a communication unit for communicating with the printer server; a storage unit for storing the information captured by the debug utility; and a terminal control unit for sending the error recovery request signal and the information captured by the debug utility to the printer server through the communication unit.

The printer server preferably includes a communication unit for communicating with the user terminal; a database for storing the debug utility; and a server control unit for reading out and sending the debug utility stored in the database to the user terminal if the error recovery request signal is received from the user terminal through the communication unit.

The debug utility preferably automatically sets parameter values of printer driver registration information to predetermined values to capture information related to the error.

Preferably, the debug utility sets a spool data format of the printer driver in an Enhanced Meta File format.

Preferably, the information captured by the debug utility includes information on an operating system of the user terminal, information on the printer driver, and information on print data. The terminal control unit preferably generates a certain file for the information captured by the debug utility and sends the file to the printer server.

In order to achieve the above described aspects, an error-processing method for an error-processing system for printers according to an embodiment of the present invention comprises the steps of sending an error recovery request signal to the printer server if an error occurs during print jobs for print data in use of the printer; providing the user terminal with a debug utility capable of capturing information related to the error if the error recovery request signal is received; installing the debug utility transferred from the printer server into the printer driver and sending the information captured by the installed debug utility to the printer server; and receiving the information captured by the debug utility from the user terminal, finding out and solving a cause of the error, and sending the result to the user terminal.

Preferably, the information captured by the debug utility includes information on an operating system of the user terminal, information on the printer driver, and information on the print data, and the user terminal generates a certain file for the information captured by the debug utility and sends the file to the printer server.

Further, the debug utility automatically sets parameter values of printer driver registration information to certain values to capture information related to the error.

Preferably, the debug utility automatically sets a spool data format of the printer driver to an Enhanced Meta File format.

### BRIEF DESCRIPTION OF THE DRAWINGS

The invention will be described in detail with reference to the attached drawing figures in which:

FIG. 1 is a block diagram for showing an error-processing system for printers according to an embodiment of the present invention;

FIGS. 2 and 3 are flow charts for explaining an error-processing method for an error-processing system for printers shown in FIG. 1;

FIGS. 4a-4d are views for explaining the debug utility program installation and report file generation steps of FIG. 3; and

FIG. 5 is a view for showing a display window based on execution of a report file generated in FIG. 3.

In the drawing figures, it will be understood that like reference numerals refer to like features and structures.

### DETAILED DESCRIPTION OF THE PREFERRED EMBODIMENT

Hereinafter, the present invention will be described in detail with reference to the attached drawing figures.

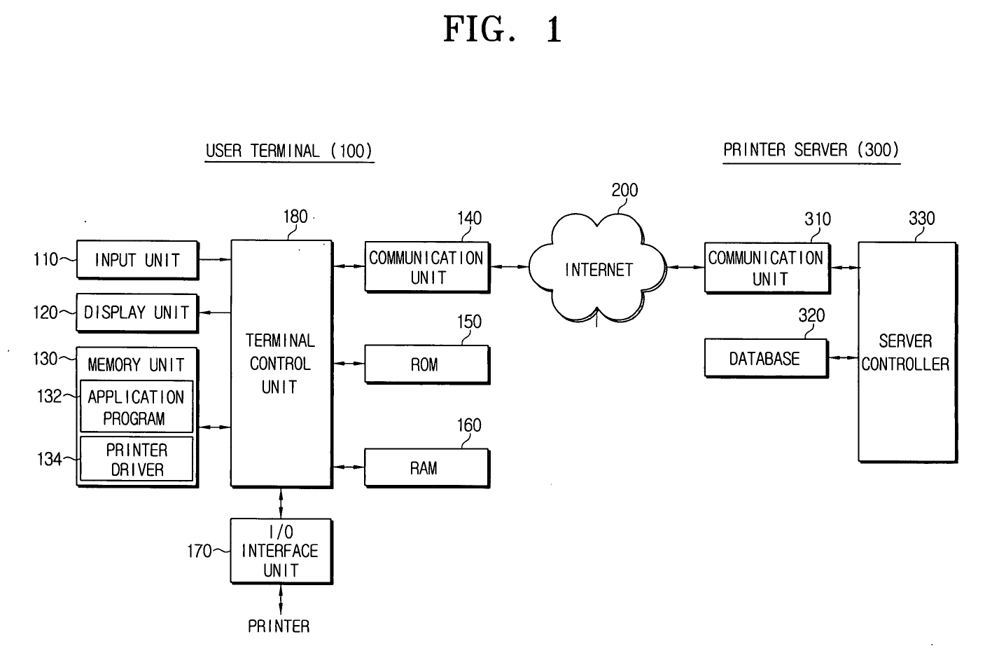

FIG. 1 is a block diagram showing an error-processing system for printers according to an embodiment of the present invention.

Referring to FIG. 1, a printer error-processing system according to an embodiment of the present invention has a user terminal 100 and a printer server 300, and the user terminal and the printer server 300 are preferably connected to each other through the internet 200.

The user terminal 100 is preferably provided with an input unit 110, a display unit 120, a memory unit 130, a communication unit 140, a ROM 150, a RAM 160, an Input/Output(I/O) interface unit 170, and a terminal control unit 180. The input unit 110 applies a key input signal to the terminal control unit 180 as a user manipulates keys. The display unit 120 displays operation states of the user terminal 100 under the control of the terminal control unit 180. The memory unit 130 stores an application program 132 and a printer driver 134 that are installed in the user terminal 100. The application program 132 is a program with which a user can prepare various documents. The printer driver 134 converts documents prepared in the application program 132 into a language that the printer can interpret, and sends the converted data to a printer. The printer driver 134 provides a print condition information setting window enabling a user to set various print conditions for print documents.

The communication unit 140 provides a communication interface for communicating with external devices connected through the internet 200. Such a communication unit 140 can communicate with external devices in a wired or wireless manner. The communication unit 140 according to an embodiment of the present invention communicates with a printer server 300 as an external device under the control of the terminal control unit 180. That is, the communication unit 140 sends an error recovery request signal to the printer server 300 for printer errors under the control of the terminal control unit 180. Further, the communication unit 140 receives a debug utility program transferred from the printer server 300 in response to the error recovery request signal.

The ROM 150 is a non-volatile memory device, and stores various control programs necessary to perform functions of the user terminal 100. The RAM 160 is a volatile memory device, and temporarily stores data according to the execution of the program of the terminal control unit 180. The I/O interface unit 170 is adapted to be connectable with a printer, and controls data communication between the printer and the terminal control unit 180. That is, the I/O interface unit 170 sends image data converted by the printer driver 134 to a printer, or receives information coming from the printer.

The terminal control unit 180 controls the overall operations of the user terminal 100 according to the program stored in the ROM 150. If a print command is received for a document prepared in the application program 132 through the input unit 110, the terminal control unit 180 executes the printer driver 134 stored in the memory unit 130. The printer driver 134 provides a print condition information setting window on the display unit 140 in order for a user to be able to set print conditions for a print document. The user uses the print condition information setting window to set print conditions such as paper size, paper orientation, the number of sheets, and so on. If the print condition information is set up, the printer driver 134 converts the print document into image data the printer can interpret, and sends the converted image data to the printer.

In the meantime, if a print error occurs while the printer performs its print job, a user determines whether the error occurring is an error he or she can fix. If the user decides that the error occurring is an error he or she can not fix, the user requests the printer server 300, which provides printer information, to fix the error. Errors occurring in a printer may be errors due to mechanical defects such as paper jams, insufficient toner, and the like, and errors due to software defects such as driving errors of the printer driver 134 and the like.

If the printer server 300 transfers a debug utility capable of capturing information on the user terminal 100 in response to an error recovery request signal, the terminal control unit 180 installs the transferred debug utility into the errored printer driver 134. At this time, the debug utility installed in the printer driver 134 sets registration information parameter values of the printer driver 134 to certain values in order to capture error print data, pre-set print conditions, and so on. For example, the debug utility is set for the printer driver to have a spool function, and, upon setting up the spool function, an option of “print after last page is spooled” is selected. Further, a spool data format is preferably set in the Enhanced Meta File (EMF) format.

The debug utility according to the present invention has a function for capturing operating system information on the user terminal 100, information on the printer driver 134, information on print data, and so on. The terminal control unit 180 generates a report file based on the information captured by the debug utility, and sends the file to the printer server 300.

In the meantime, the printer server 300 has a communication unit 310, a database 320, and a server control unit 330.

The communication unit 310 provides a communication interface for communicating with the user terminal 100 connected through a network such as the Internet 200. The communication unit 310 performs mutual data communications with the user terminal 100 according to the controls of the server control unit 330. That is, the communication unit 310 receives an error recovery request signal transferred from the user terminal 100, sends the signal to the server control unit 330, and sends the debug utility transferred from the server control unit 330 to the user terminal 100 that has sent the error recovery request signal.

The database 320 stores the debug utility capable of capturing information on the user terminal 100 in response to the error recovery request signal, and a playback program for executing a report file corresponding to the captured information on the user terminal 100 that is transferred from the user terminal 100.

The server control unit 330 controls the overall operations of the printer server 300. If the server control unit 330 receives an error recovery request signal from the user terminal 100 through the communication unit 310, the server control unit 330 reads out the debug utility stored in the database 320, and sends the utility to the user terminal 100 requesting an error recovery.

Further, if the server control unit 330 receives a report file corresponding to the information captured by the debug utility from the user terminal 100 through the communication unit 310, the server control unit 330 runs the playback program stored in the database 320 to read out information included in the report file. Further, the server control unit 330 sets the system environments of the printer server 300 equal to the system environments of the user terminal 100 in use of the information of the user terminal 100 that has been read out by the playback program. After the system environments of the printer server 300 is set equal to the system environments of the user terminal 100, the server control unit 330 simulates the faulty print job for the print data, and determines a cause of the error. If the cause of the error is determined and the error is fixed, the server control unit 330 sends the corrected printer driver to the user terminal 100.

Accordingly, if an error occurs in a printer, the present invention enables service technicians or printer developers to simulate the error in the printer at a distance using information captured by the debug utility without visiting the site where the printer in error is located.

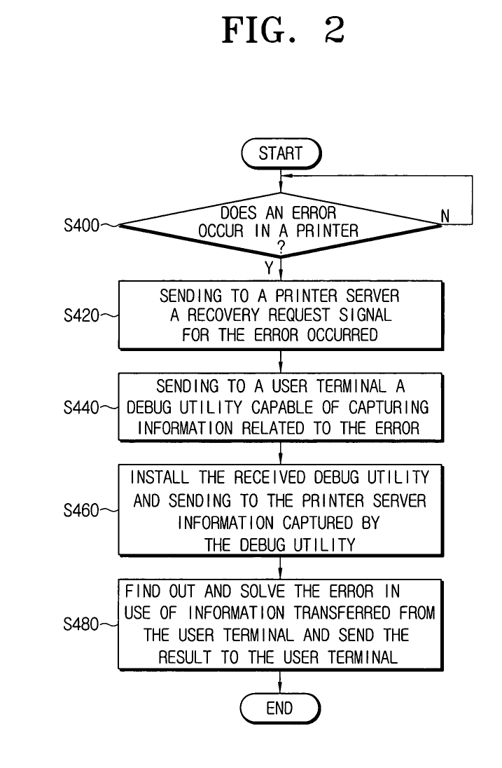

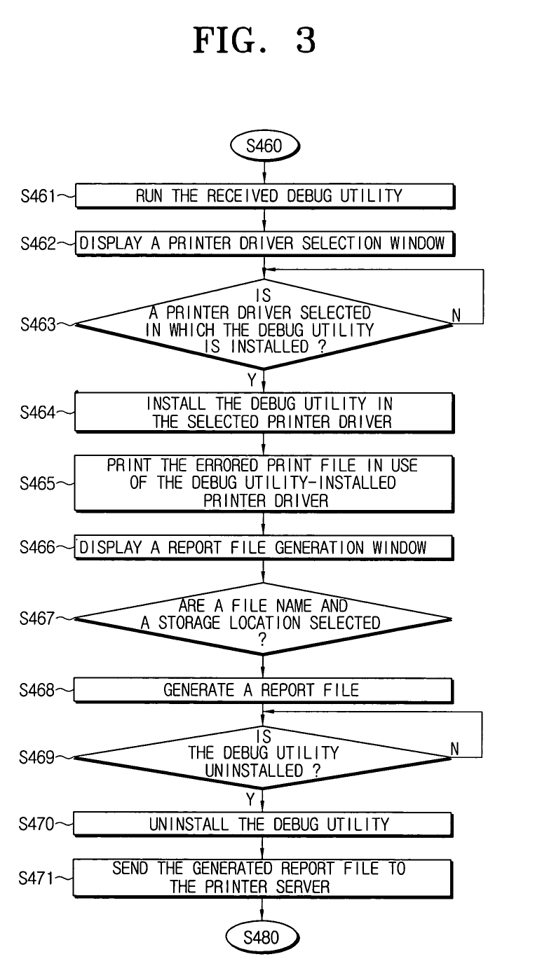

Hereinafter, an error-processing method for an error-processing system for printers according to an embodiment of the present invention will be described with reference to FIG. 2 and FIG. 3.

First, the terminal control unit 180 decides whether a printer has an error during performing a print job (S400). If the printer is determined to have an error, the terminal control unit 180 sends an error recovery request signal to the printer server 300 connected through the internet 200 (S420). If an error recovery request signal is received from the user terminal 100, the server control unit 330 sends a debug utility stored in the database 320 to the user terminal 100 (S440).

If the debug utility is received from the printer server 300, the terminal control unit 330 installs the received debug utility into the faulty printer drive, and sends information captured by the installed debug utility to the printer server 300 (S460).

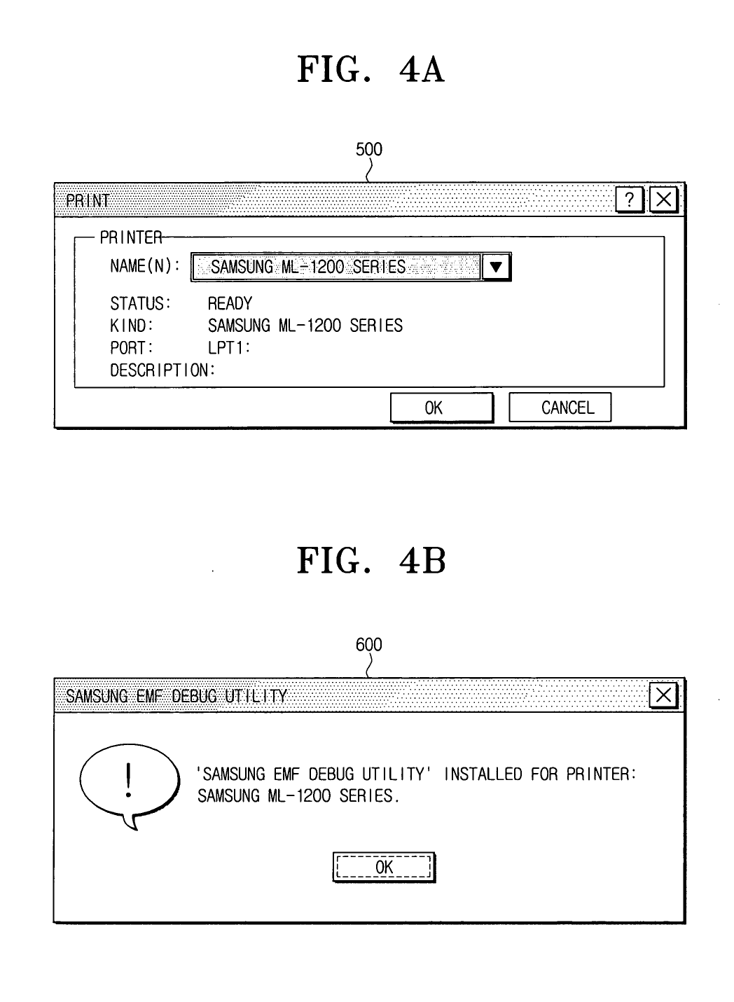

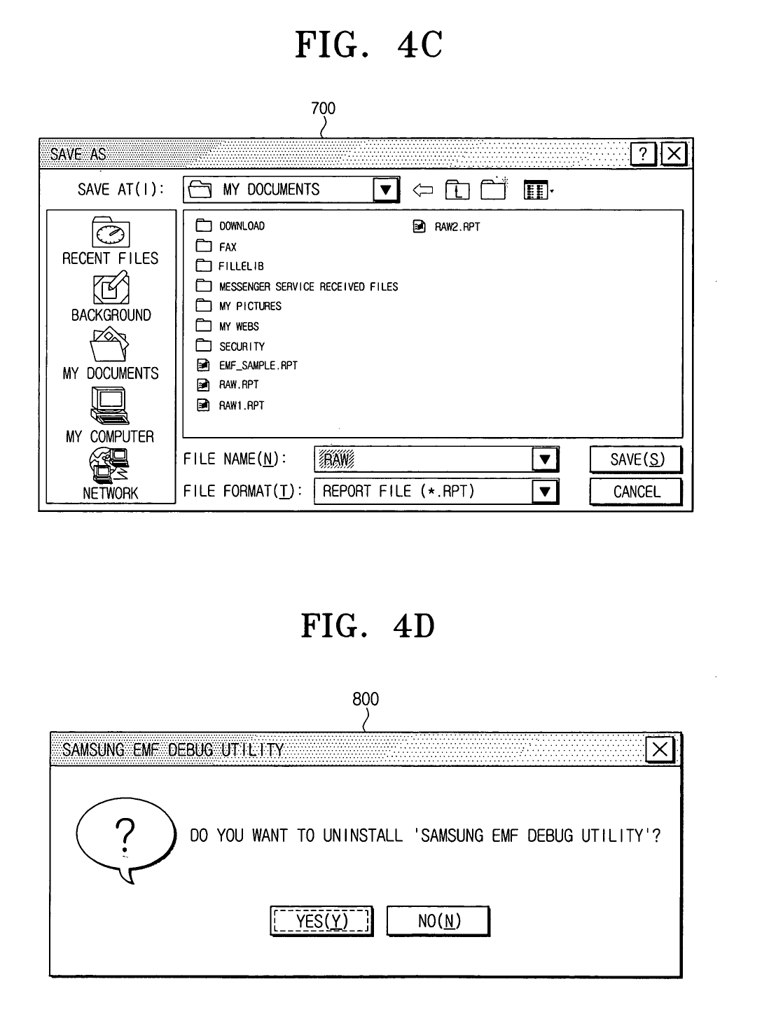

The step S460 for installing the debug utility will now be described in more detail with reference to FIG. 3. If the debugging program is received from the printer server 300, the terminal control unit 180 runs the received debug utility (S461). If the debug utility is run in step S461, a printer driver selection window 500 as shown in FIG. 4a is displayed on the display unit 120 (S462). A user can select a printer driver in which the debug utility is installed through the printer driver selection window 500 displayed on the display unit 120. At this time, the user selects the printer driver employed when the error occurred. If a printer driver for the debug utility to be installed into is selected by the user (S463), the debug utility is installed in the selected printer driver (S464). If the debug utility is completely installed, an installation-complete display window 600 is displayed on the display unit 120 as shown in FIG. 4b, which notifies that the debug utility has been installed in the corresponding printer driver.

If the debug utility is completely installed in the step S464, the user inputs a print command to perform the faulty print job for the print file using the debug utility-installed printer driver (S465). If the print command is received, a report file generation window 700 is displayed on the display unit 120 to generate a report file. The report file generation window 700 enables the user to determine the file name and storage location of the report file to be generated based on information of the user terminal 100 that has been captured by the debug utility (S466). FIG. 4c illustrates an exemplary report file generation window 700. If a file name and a storage location for the report file to be generated is selected (S467), the report file is generated including the information captured by the debug utility (S468).

If the report file is completely generated in the step S468, a program uninstallation menu window 800 is displayed on the display unit 120 as shown in FIG. 4d, which enables a user to decide whether to uninstall the debug utility installed in the printer driver. If a program uninstallation command is received by the user (S469), the terminal control unit 180 uninstalls the debug utility installed in the printer driver (S470). If the debug utility is not uninstalled after the report file generation, the report file generation step affects the time for print jobs since the report file generation step is repeated every time a user performs a print job in use of the printer driver. Accordingly, the user may prefer to uninstall the debug utility installed in the printer driver after the report file generation.

If the report file including the information on the user terminal 100 is generated through the above process, the terminal control unit 180 sends the generated report file to the printer server 300 through the communication unit 140 (S471).

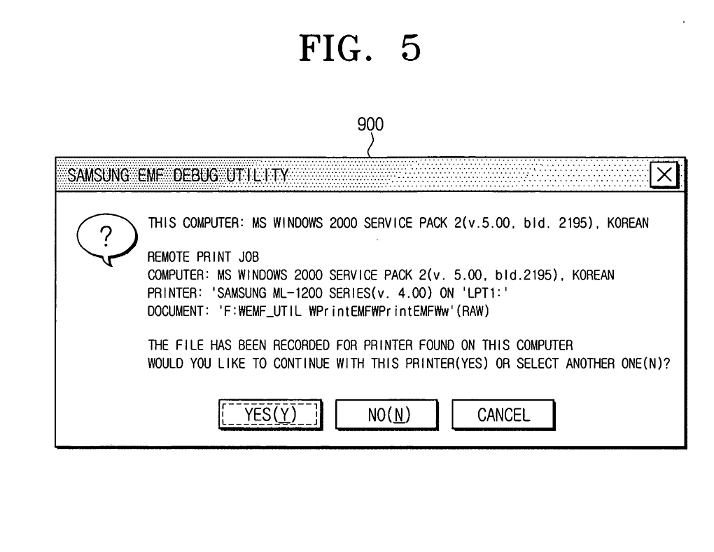

The printer server 300 determines and solves a cause of the error using the report file transferred from the user terminal 100 (S480). In more detail, if the report file is received through the communication unit 310, the server control unit 330 runs the playback program stored in the database 320 and reads out the received report file. At this time, a user terminal information display window 900 is displayed on the display unit 120 as shown in FIG. 5. The user terminal information display window 900 displays operating system information of the printer server 300, operating system information of the user terminal 100, printer driver information, information on a print file, and so on, as shown in FIG. 5. The server control unit 330 sets the system environments of the printer server 300 equal to the system environments of the user terminal 100 using the information included in the report file, simulates the error that occurred in the user's printer, and determines and solves the cause of the error. If the error is completely fixed, the server control unit 330 provides the user terminal 100 with the corrected printer driver.

As described so far, the error-processing system and method for printers according to embodiments of the present invention can obtain information on errors occurring in printers through a program to enable service technicians and printer developers to simulate and solve the errors without visits to the locations where the faulty printers are placed upon error-fix requests, to thereby reduce the time for fixing the errors.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. An error-processing system for printers, comprising:
a user terminal installed with a print driver for controlling drives of a printer, and adapted to send an error recovery request signal to an external server providing information on the printer when an error occurs during a print job; and
a printer server adapted to receive the error recovery request signal and provide the user terminal with a debug utility program capable of capturing information related to the error, and, if the information captured by the debug utility is received from the user terminal, to determine and solve a cause of the error using the received information, and to provide the result to the user terminal, wherein the user terminal is adapted to install the debug utility into the printer driver and to send to the printer server the information captured by the installed debug utility.

2. The error-processing system as claimed in claim 1, wherein the user terminal includes:
a communication unit adapted to communicate with the printer server;
a storage unit for storing the information captured by the debug utility; and
a terminal control unit for sending the error recovery request signal and the information captured by the debug utility to the printer server through the communication unit.

3. The error-processing system as claimed in claim 1, wherein the printer server includes:
a communication unit adapted to communicate with the user terminal;
a database adapted to store the debug utility; and
a server control unit adapted to, if the error recovery request signal is received from the user terminal through the communication unit, send the debug utility stored in the database to the user terminal.

4. The error-processing system as claimed in claim 1, wherein the debug utility is adapted to automatically set parameter values of printer driver registration information to predetermined values to capture information related to the error.

5. The error-processing system as claimed in claim 1, wherein the debug utility sets a spool data format of the printer driver in an Enhanced Meta File format.

6. The error-processing system as claimed in claim 2, wherein the information captured by the debug utility includes information on an operating system of the user terminal, information on the printer driver, and information on print data, and wherein the terminal control unit is adapted to generate a certain file for the information captured by the debug utility and to send the file to the printer server.

7. An error-processing method for an error-processing system for printers wherein the system has a user terminal installed with a printer driver to control drives of a printer and a printer server connected through the internet, comprising steps of:
sending an error recovery request signal to the printer server if an error occurs during print jobs for print data using the printer;
providing the user terminal with a debug utility capable of capturing information related to the error if the error recovery request signal is received;
installing the debug utility transferred from the printer server into the printer driver and sending the information captured by the installed debug utility to the printer server; and
receiving the information captured by the debug utility from the user terminal, determining a cause of the error and solving the error, and sending the result to the user terminal.

8. The error-processing method as claimed in claim 7, wherein the information captured by the debug utility includes information on an operating system of the user terminal, information on the printer driver, and information on the print data, and further comprising the steps of generating a certain file for the information captured by the debug utility and sending the file to the printer server.

9. The error-processing method as claimed in claim 7, wherein the debug utility automatically sets parameter values of printer driver registration information to certain values to capture information related to the error.

10. The error-processing method as claimed in claim 7, wherein the debug utility automatically sets a spool data format of the printer driver to an Enhanced Meta File format.

11. An error-processing system comprising:
a printer server adapted to receive an error recovery request signal from a user terminal, to provide the user terminal with a debug utility program capable of capturing information related to the error, to receive information captured by the debug utility, and to determine a cause of the error based on the received information.

12. The error-processing system of claim 11, wherein the printer server further comprises:
a communication unit adapted to communicate with the user terminal;
a database adapted to store the debug utility; and
a server control unit adapted to send the debug utility stored in the database to the user terminal in response to the error recovery request signal.
